(19) United States
(12) Patent Application Publication
(10) Pub. No.: US 2004/0215565 A1
(43) Pub. Date: Oct. 28, 2004

(54) Personal integrated banking

(76) Inventor: Russell Bruce Huffman, Arroyo Grande, CA (US)

Correspondence Address: RUSSELL B. HUFFMAN, 2765 Indian Hills Way, Arroyo Grande, CA, 93420, US

(21) Appl. No.: 10/005,644

(22) Filed: Dec. 7, 2001

(51) Int. Cl. G06F 17/60

(52) U.S. Cl. 705/42; 705/39

(57) ABSTRACT

“Personal Integrated Banking” is an interactive electronic data processing software utility banking system which integrates individual account transactions into seamless, on line, running balance Statements and Budget Reports.

Sequential integers; or alternatives thereof; derived from a pre formatted, “Budget Key Code Card”; allows customers to interactively categorize all account transactions and customize, change or create destinations and categories for; INCOME, (credit) and EXPENSE, (debit) transactions.

Customers may highlight and print screens or selected transactions. All account activity is equated thru (C−D=B); “(credits), (C), minus debits, (D), equals balances, (B)”; and integrated into Balance Statements and Budget Reports. Additional screens back up all transactions. Expanded system utilization provides building blocks for complete commercial and paperless banking systems. All banking entries are view only.

### SUMMARY

P.I.B. (Personal Integrated Banking) is a data process/system designed to integrate all individual customer banking functions into a paperless, on line seamless array of customer accessible documents 24 hours a day. All accounts are encrypted within each banks individual security systems.

Until such time as P.I.B. becomes a standard for banking; variety and individuality of data processing, software and in some cases hardware for P.I.B will require P.I.B. to be custom fit to each banks requirements.

P.I.B. integrates into a seamless, paperless on line presentation available via direct internal or linked via out source on line banking computer systems.

All customer banking activities culminate in very near real time visual data presentation of all checking, credit card, bank charges, loan, savings, credits, debits, balances and deposits presented in multiple individual seamless visual documents.

For ease of account reconciliation; deposits and expenses are shown as continuous running totals. Credits, less debits are shown as a running balance. Each income and budget key category is shown as budget minus expense equals an over or under & balance.

P.I.B. fixed predesignated key codes with variable categories enable customers to change or enter new categories for all debit and credit activities. Repetitive or individual transactions may be pre-encoded to a particular category, i.e., automatic credits or debits.

P.I.B. integrates all individual customer transaction data culminating in a complete general budget statement. Not every customers categories will be the same. Complete, continuous budget tracking becomes available on a 24 hour basis as well as monthly and yearly reporting. All data presented thru transactions, i.e., checks, deposits, payments etc. become selectable and printable by each customer.

Customers can review individual Key codes and monthly expenses entered into each key code. All bank generated debit and credit data are read only and cannot be changed by customers, only budget income and categories are variable and subject to customer change.

### PROPOSED

### P.I.B. CHECK BOOK KEY CARD

| INCOME | EXPENSES |
|---|---|
| 1. INTEREST | 11. ACCOUNTING |
| 2. DIVIDENDS | 12. AUTO MAINT. |
| 3. EMPLOY | 13. AUTO FUEL |
| 4. SS1 | 14. AUTO R&L |
| 5. SS2 | 15. CABLE TV |
| 6. STK. SALES | 16. CALXX TAX |
| 7. PENSIONS | 17. CALXX EST TX |
| 8. CASH IN | 18. CLOTHING |
| 9. OTHER | 19. ENTERTAIN |
| 10. Save Acc | 20. DONATIONS |
| | 21. DRY CLEAN |
| | 22. FED XX TAX |
| | 23. FED EST TAX |
| | 24. FOOD |
| | 25. GAS CO |
| | 26. GARDENING |
| | 27. GAS CO |
| | 28. GIFTS |
| | 29. GYM EXP. |
| | 30. HEATH INS |
| | 31. HM. IMPS |
| | 32. HM. MAIN |
| | 33. HM. CLEAN |
| | 34. HOME INS |
| | 35. HOSPITAL |
| | 36. INTEREST |
| | 37. LIFE INS |
| | 38. MEDICARE |
| | 39. MEDICATIONS |
| | 40. OFFICE |
| | 41. PETTY CASH |
| | 42. PERS. PROP |
| | 43. PERS. HYG. |
| | 44. POWER |
| | 45. RECREATION |
| | 46. RETAXES |
| | 47. TELEPHONE |
| | 48. TRASH |
| | 49. TRAVEL |
| | 50. VACATIONS |
| | 51. VETERINARY |
| | 52. VITAMINS |
| | 53. INTER NET |
| | 54. MISC. |
| | 55. Hm Mo In |
| | 56. Auto In |
| | 57. Hm EqIn |
| | 58. Doctors |
| | 59. |
| | 60. |
| | 61. |
| | 62. |
| | 63. |
| | 64. |
| | 65. |
| | 66. |
| | 67. |
| | 68. |
| | 69. |
| | 70. |
| | 71. |
| | 72. |
| | 73. |

This ck. book key card is the integral portion of the P.I.B. system. IT enables customers to key income and expense entries to their personal budgets from their individual cheque books, credit card, atm deposits or withdrawals. ALL bank generated entries are read only transaction records. And can not be changed. By the customer.

Resource categories of the key card may be added to or changed to satisfy customer needs. Viewing screens are seamless. Designated intergers of the key card. Once the integers are used up, no further additions are possible. It is envisioned that 100 key codes would be possible.

The format shown is suggested to be an integral sheet in each perosnal check record book. Having the key card in one scheck book allows ready reference. A wallet size would be a handy reference for credit card purchases.

### P.I.B. System Flow Chart

### Description

The P.I.B. system flow chart shown on page 4 represents the flow path of customer entered key integers associated with each transaction. Extrapolated and refined in some transactions; additional bank generated data is also transferred to designated screens/pages and viewed on customers view able computer screens.

[image]

Each new year or optional customer timing; customers enter expected budget income and expenses in proper corresponding key P.I.B. categories. Screen 1, (budget report), utilizes P.I.B. references card integers for proper budget or expense allocations.screen 2, (bank statement) presents realtime bank established data with running balances and other pertinent data for; checks, credit charges, mortgages and loan balances etc.; screen 3, (records) are derives from data normally used to generate and mail paper statements. All bank entries to each screen are read only.

ANY BANK . . . U.S.A. or international, P.I.B. system. Screen #1
CUSTOMER NAME/ADDRESS. ACCOUNT # XXXXXXXXXX
Year 2001 ytd or month {11} AS OF 11/31/01

| Key | | | | | |
|---|---|---|---|---|---|
| 1-54 | P.I.B. BUDGET BANKING REPORT | | | | |
| INCOME | AMOUNT | Date | Ref # or Quan | Amount | Description |
| 1. INTEREST | 500.00 | 08/01/01 | 1 | 500.00 | FIRST CLEARING CREDIT |
| 2. DIVIDEND | 2500.00 | 08/01/01 | 3 | 2500.00 | SEE SCREEN #2 |
| 3. SS1 | 950.00 | 10/31/01 | 1 | 950.00 | US TREAS 310 SOC SEC |
| 4. SS2 | | | | | |
| 5. STK SALES | 3000.00 | 11/01/01 | 1 | 3000.00 | VECO |
| 6. PENSIONS | | | | | |
| 7. CASH IN | | | | | |
| 8. EMPLOYMENT | 500.00 | 10/29/01 | 1 | 500.00 | AMBER CO |
| 9. CK DEPOSITS | | | | | |
| 10. SAVINGS | 459.00 | 11/31/01 | 3 | 459.00 | SEE SCREEN #2 |
| TOTAL | $7909.00 | | | | |

| EXPENSES | Budget | Date | # of Transactions | AMOUNT | $ OVER | $ UNDER |
|---|---|---|---|---|---|---|
| 11. ACCOUNTING | | | | | | |
| 12. AUTO MAINT | | | | | | |
| 13. AUTO FUEL | | | | | | |
| 14. AUTO R&L | | | | | | |
| 15. CABLE TV | | | | | | |
| 16. CAL XX TAX | | | | | | |
| 17. CALXX EST TX | | | | | | |
| 18. CLOTHING | 500.00 | 10/25/01 | 1 | 250.00 | | 250.00 |
| 19. ENTERTAIN | | | | | | |
| 20. DOCTORS | | | | | | |
| 21. DONATIONS | 200.00 | 09/15/01 | 1 | 200.00 | | |
| 22. DRY CLEAN | 250.00 | 08/15/01 | 1 | 500.00 | 250.00 | |
| 23. FED XX TAX | | | | | | |
| 24. FED EST TAX | | | | | | |
| 25. FOOD | 250.00 | See key 25 | 2 | 100.00 | | 150.00 |
| 26. GAS CO | | | | | | |
| 27. GARDENNG | | | | | | |
| 28. GIFTS | 300.00 | 11/31/01 | 1 | 200.00 | | 100.00 |
| 29. GYM EXP | | | | | | |
| 30. HEATH INS | | | | | | |
| 31. HM IMPS | | | | | | |
| 32. HM MAIN | | | | | | |
| 33. HM CLEAN | | | | | | |
| 34. HOME INS | | | | | | |
| 35. HOSPITAL | 100.00 | 12/26/01 | 1 | 100 | 0 | 0 |
| 36. INTEREST | | | | | | |
| 37. LIFE INS | | | | | | |
| 39. MEDICARE | | | | | | |
| 39. MEDICATIONS | | | | | | |
| 40. OFFICE | 400.00 | 07/13/01 | 1 | 94.14 | | 305.86 |
| 41. PETTY CASH | | | | | | |
| 42. PERS PROP | | | | | | |
| 43. PERS HY | | | | | | |
| 44. POWER | | | | | | |
| 45. RECREATION | | | | | | |
| 46. RE TAXES | | | | | | |
| 47. TELEPHONE | | | | | | |
| 48. TRASH | | | | | | |
| 49. TRAVEL | | | | | | |
| 50. VACATIONS | | | | | | |
| 51. VETERINARY | | | | | | |
| 52. VITAMINS | 400.00 | 06/15/0 | 1 | 4.00 | | 396.00 |
| 53. INTERNET | 287.00 | See Key 53 | 11 | 262.90 | | 24.10 |
| 54. MISC. | | | | | | |

| | |
|---|---|
| TOTALS | |
| INCOME | $7,909.00 |
| BUDGET EXPENSES | ($2,687.00) |
| INCOME BALANCE | $5,322.00 |
| EXPENSES TO DATE | ($1,711.04) |
| INCOME BALANCE | $3,610.96 |
| BUDGET BALANCE | $975.96 |

| | |
|---|---|
| UNDERBUDGET | $1,225.96 |
| OVERBUDGET | $(250.00) |
| Total | $975.96 |

Key Transactions Tally Sheet Year 2001

| | Budget | Month | Amt. | Total |
|---|---|---|---|---|
| Key #25 | 250.00 | NOV 13 | 65.25 | 65.25 |
| | | NOV 13 | 34.75 | 100.00 |
| Key #28 | 300.00 | Nov 31 | 200.00 | 200.00 |
| Key #40 | 400.00 | NOV 13 | 94.14 | 94.14 |
| Key #53 | 23.90 | Jan 5 | 23.90 | 23.90 |
| | 23.90 | Feb 5 | 23.90 | 47.80 |
| | 23.90 | Mar 5 | 23.90 | 71.70 |
| | 23.90 | Apr 5 | 23.90 | 95.60 |
| | 23.80 | May 5 | 23.90 | 119.50 |
| | 23.90 | Jun 5 | 23.90 | 143.40 |
| | 23.90 | Jul 5 | 23.90 | 167.30 |
| | 23.90 | Aug 5 | 23.90 | 191.20 |
| | 23.90 | Sep 5 | 23.90 | 215.10 |
| | 23.90 | Oct 5 | 23.90 | 239.00 |
| | 23.90 | Nov 5 | 23.90 | 262.90 |

ANY BANK . . . U.S.A. or international P.I.B. screen . . . #2
CUSTOMER NAME/ADDRESS. ACCOUNT #
XXXXXXXXXX
STATEMENT
Funds (CREDITS): Received FROM 01/31/01 - TO
11/31/01
Balance carry fwd. from 01/31/00 X = XXXXXXXX

| KEY | Date | Ref # | Amount | Credits | Description/notes | TOTAL$ |
|---|---|---|---|---|---|---|
| 1. Interest | 08/01/01 | | 500.00 | | XYZ Stock | X + 500 |
| 2. Dividends | 08/01/01 | | 500.00 | | KHI Income fund | 1,000 |
| | 08/15/01 | | 1000.00 | | XYZ Corp. | 2,000 |
| | 10/19/01 | | 1000.00 | | XXX Corp. | 3,000 |
| 8. Employment | 10/29/01 | | 500.00 | | J. Mfg. | 3,500 |
| 3. SSI | 10/31/01 | | 950.00 | | US TREASURY | 4,450 |
| 5. Stk. Sales | 11/01/01 | | 3000.00 | | VECO | 7,450 |
| 10. Savings | 11/31/01 | | 250.00 | | Extra work | 7,700 |
| | 10/15/01 | | 150.00 | | Extra work | 7,850 |
| | 11/31/01 | | 59.00 | | Extra work | 7,909 |
| Misc. Deposits | | | | | | |

| | |
|---|---|
| Previous Credit total | 10/31/01 = $4,450.00 |
| Total credits on | 11/31/0 = $7,909.00 |

Last date shown are your TOTALCREDITS

NOTE: KEY #2 & #10 Demonstrates multiple deposits. NOTE: Misc. deposits KEY #9.
are not income.
10-54

Expenses (DEBITS):

| KEY | Cheques | $Amount | Transaction No. | Date | TOTAL |
|---|---|---|---|---|---|
| 22 | 231 | 500.00 | 1 | 08/15/01 | 500 |
| 23 | 232 | 200.00 | 1 | 09/15/01 | 700 |
| 18 | 233 | 250.00 | 2 | key 25 | 950 |
| 35 | ATM | 100.00 | xxxxxxxxx | 11/26/01 | 1,050 |
| 25 | Debit | 100.00 | XXXXXXXX | 11/13/01 | 1,150 |
| 28 | Sav | 200.00 | 1 | 11/31/01 | 1,350 |
| 40 | 234 | 94.14 | 1 | 11/13/01 | 1,444.14 |
| 52 | 235 | 4.00 | 1 | 11/15/01 | 1,448.14 |
| 53 | Debit | 262.90 | 11 | key 53 | 1,711.04 |

Add any credits, minus any debits not shown to arrive at Near Real Time
Balance.]$ current balance, [+credits − debits] = Near Real Time
Balance $

Savings Account No. xxxxxxxxxxxxx on date shown.

| | |
|---|---|
| Deposits. | Withdrawals |

| KEY | | KEY | | Date | Balance |
|---|---|---|---|---|---|
| 10 | 250.00 | | | 09/09/01 | 250.00 |
| 10 | 150.00 | | | 10/15/01 | 400.00 |
| 10 | 059.00 | 28 | 200.00 | 11/31/01 | 259.00 |

[image]

[image]

[image]

[image]

[image]

[image]

1. P.I.B. (personal integrated banking) system claims and establishes a new form of banking.

2. PIB is the first fully integrated, interfaced customer data processing personal banking system providing a fully integrated budget reporting system.

3. Provides banks with a system of eliminating mailing volumes of paper documents, i.e., statements, return checks, mortgage statements, credit card statements, loan statements and the like.

4. Pre designated key codes, and generation of integrating software, allows most bank processing of customer banking information not to change. Only formats and method of presentation are necessary.

5. Significant cost reductions of processing and use of paper and printing of customer documentation will enhance banking profits.

6. Customers are provided with a personal interface linked to their bank interfaced with a budget application under their control with out time consuming entries in additional budget programs.

7. Near real time balances and statements are integrated and presented for customers visual 24 hour review of checking, credit cards purchases, loans, mortgage, loan balances, ATM and saving account transactions in variable time periods of. daily, monthly or yearly.

8. Customers may select and print for their records, daily, yearly or monthly, copies of all selected materials and transactions, i.e., checks credit cards, checking statements, loan documents, savings accounts, mortgage statements or various graphs of financial relevance.

9. Does not interfere with existing Federal banking systems and procedures.

10. Until P.I.B. is an established banking system it is optional for customers wishing to keep paper bank reporting.
